(19) United States
(12) Patent Application Publication
(10) Pub. No.: US 2026/0120363 A1
(43) Pub. Date: Apr. 30, 2026

(54) DISPLAY CONTROL APPARATUS AND CONTROL METHOD THEREFOR

(71) Applicant: CANON KABUSHIKI KAISHA, Tokyo (JP)

(72) Inventors: KENTAROU NAKAMURA, Shizuoka (JP); KOTARO MATSUDA, Kanagawa (JP)

(21) Appl. No.: 19/365,536

(22) Filed: Oct. 22, 2025

(30) Foreign Application Priority Data
Oct. 30, 2024 (JP) 2024-190897

(51) Int. Cl. G06T 11/60

(52) U.S. Cl. CPC G06T 11/60

(57) ABSTRACT

A display control apparatus comprises: a management unit that manages defect information regarding a plurality of defects occurring in a target object; and a display control unit that displays information regarding one or more defects corresponding to a partial region of the target object based on the defect information. The defect information includes shape information, identification information, and additional information of each of the plurality of defects. The display control unit displays one or more defect objects respectively corresponding to the one or more defects based on the shape information, displays one or more first labels indicating identification information respectively corresponding to the one or more defects, and displays a second label not overlapping another label, and does not display at least one second label overlapping another label.

### BACKGROUND

### Field of the Technology

The present disclosure relates to a technology for displaying information regarding a defect in an image in which an inspection target is shot.

### DESCRIPTION OF THE RELATED ART

On a concrete surface of a bridge or a building, a defect (crack, water leak, and the like) may occur due to various factors. In recent years, a system that automatically detects a defect by inputting, to a computer, an inspection image in which a concrete surface is shot with a camera has begun to spread, and digitization of inspection has progressed. Japanese Patent Laid-Open No. 2024-000324 discloses a method for managing a defect detection result as defect information by assigning identification information unique to individual defects detected from an inspection image.

An inspector needs to display the inspection image and the defect information on a screen of a computer to confirm the validity of the defect detection result. However, in a case where a plurality of defects exist at a high density in a range of the inspection image to be displayed, there is a problem that readability of identification information/additional information of individual defects is deteriorated.

### SUMMARY

The present disclosure provides a display control technology for improving readability of information regarding a plurality of defects in an inspection image.

A display control apparatus comprises: one or more memories storing instructions; and one or more processors executing the instructions to: manage defect information regarding a plurality of defects occurring in a target object; and display information regarding one or more defects corresponding to a partial region of the target object based on the defect information, wherein the defect information includes shape information, identification information, and additional information of each of the plurality of defects, and the one or more processors display one or more defect objects respectively corresponding to the one or more defects based on the shape information, display one or more first labels indicating identification information respectively corresponding to the one or more defects, and display a second label not overlapping the first label or the second label of another defect, and does not display at least one second label overlapping the first label or the second label of another defect, among one or more second labels indicating additional information respectively corresponding to the one or more defects.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a view illustrating a hardware configuration of a display control apparatus.

FIG. 2 is a view illustrating a functional configuration of the display control apparatus.

FIG. 3 is a view describing defect information.

FIG. 4 is a view illustrating an example of a defect display screen.

FIG. 5 is a view describing a display method for a defect ID/additional defect information.

FIG. 6 is a view describing control in a case of displaying a defect ID and additional defect information.

FIG. 7 is a flowchart of processing for display.

FIG. 8 is a view describing a variation of a display method.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

As a first embodiment of a display control apparatus according to the present invention, an information processing apparatus that controls display of information (defect object/identification information/additional information) regarding a defect in an image (inspection image) in which an inspection target object is shot will be described below as an example.

### Apparatus Configuration

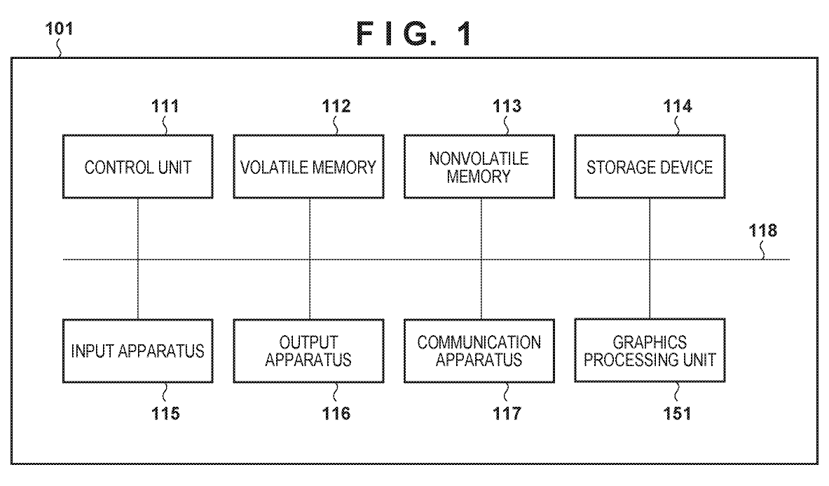

FIG. 1 is a view illustrating a hardware configuration of the information processing apparatus. In the embodiment described below, an example of use of a general computer (PC) as an information processing apparatus will be described.

A computer 101 includes a control unit 111, a volatile memory 112, a nonvolatile memory 113, a storage device 114, an input apparatus 115, an output apparatus 116, a communication apparatus 117, and a system bus 118. A graphics processing unit (GPU) 151 may be added as necessary.

The control unit 111 includes an arithmetic processing processor such as a central processing unit (CPU) that integrally controls the entire computer. The volatile memory 112 is a random access memory (RAM) that temporarily stores programs and data supplied from an external apparatus or the like. The nonvolatile memory 113 is a read-only memory (ROM) that stores programs and parameters to be executed by the processor of the control unit.

The storage device 114 is a storage such as a flash memory or a hard disk built in or externally connected to the computer 101. The storage device 114 can be configured by a combination of a storage medium such as a DVD and a drive that reads/writes data from/into the storage medium.

The input apparatus 115 is an operation unit such as a mouse, a keyboard, or a touch panel that receives a user operation, and transmits an operation instruction to the control unit 111. The output apparatus 116 is a display apparatus such as a display or a monitor, and displays a processing result of software executed by the control unit 111. The communication apparatus 117 is connected to the Internet or a local area network (LAN) and communicates with an external apparatus. The system bus 118 includes an address bus, a data bus, and a control bus that connect each component of the computer 101 so that data can be exchanged.

The nonvolatile memory 113 stores a basic input/output system (BIOS) that activates the computer 101 and controls each piece of hardware. The computer reads and executes the BIOS at the time of activation, thereby activating an operating system (OS) installed in the storage device 114.

The information processing by the computer 101 of the present embodiment is implemented by the control unit 111 executing the OS or additional software installed in the OS. A plurality of the computers 101 may be used as necessary. In that case, a server-client configuration may be adopted. For example, a form in which information processing with a large amount of calculation is performed by a server computer, and an information processing result by the server computer is viewed by a browser or the like on a client computer may be adopted. A form in which a web application provided by the server computer is executed by the client computer may be adopted.

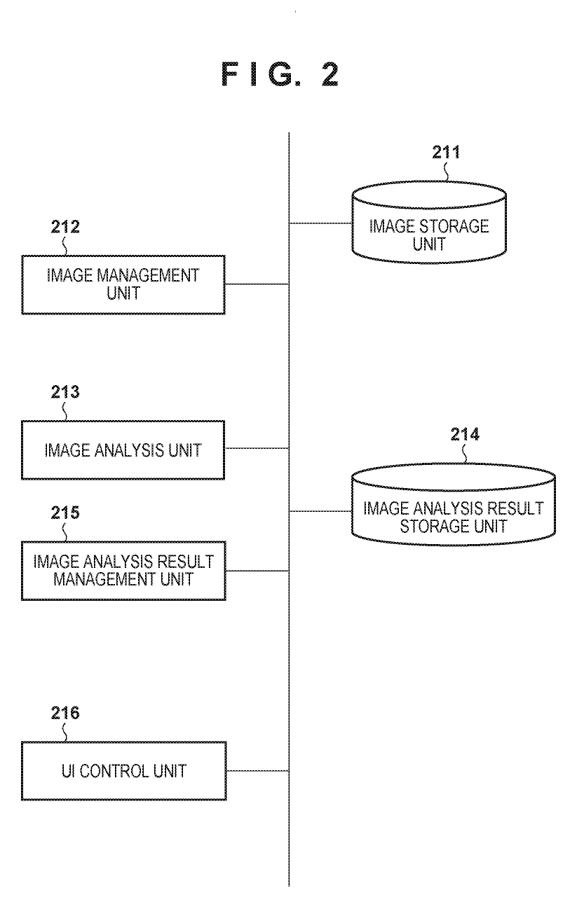

FIG. 2 is a view illustrating a functional configuration of the information processing apparatus. As described above, each function (information processing) of the information processing apparatus is implemented by the control unit 111 executing the OS or additional software installed in the OS.

An image storage unit 211 stores an image (inspection image) uploaded by the user. An image management unit 212 uniquely identifies and manages an image file stored in the image storage unit 211. For example, the image management unit 212 assigns a universal unique identifier (UUID) to an image file stored in the image storage unit 211 and manages a file name, registration date and time, and the like.

An image analysis unit 213 executes image analysis on an image file stored in the image storage unit 211 and detects a defect of a structure. An example of a technique for image analysis is a method for detecting and outputting a defect from an input image using an artificial intelligence (AI) model pre-learned by machine learning, but any other technique may be adopted. In order to perform inference processing by AI at high speed, it is possible to configure to use a GPU 151.

An image analysis result storage unit 214 stores an analysis result by the image analysis unit 213. For example, a defect detected in an inspection image is classified for each defect type (crack, water leak, and the like), and is stored as shape data of a polyline, a polygon, or the like.

An image analysis result management unit 215 manages association between an image stored in the image storage unit 211 and an analysis result stored in the image analysis result storage unit 214. Note that, even in a case where image analysis is performed on one image a plurality of times, the image analysis result management unit 215 can collectively associate the one image with the plurality of analysis results.

An user interface (UI) control unit 216 displays, on a display unit that is the output apparatus 116, data (an image and an image analysis result) managed and stored by each of the above-described functional units. A UI for receiving an operation by a user input is displayed on the display unit. The UI control unit 216 may be implemented by a local application of the computer 101, or may be implemented by a browser of the computer 101 executing a web application provided by a server.

### Defect Information and Display of Defect Information

In inspection of a concrete surface, examples of the defect type include a crack, water leak, rust stains, reinforcing bar exposure, and efflorescence. Hereinafter, a form in which individual defects are assigned with identification information and managed as a target of "crack" and “water leak", which are representative defect types, will be described. Additional information (width, length, area, and the like) is managed for individual defects.

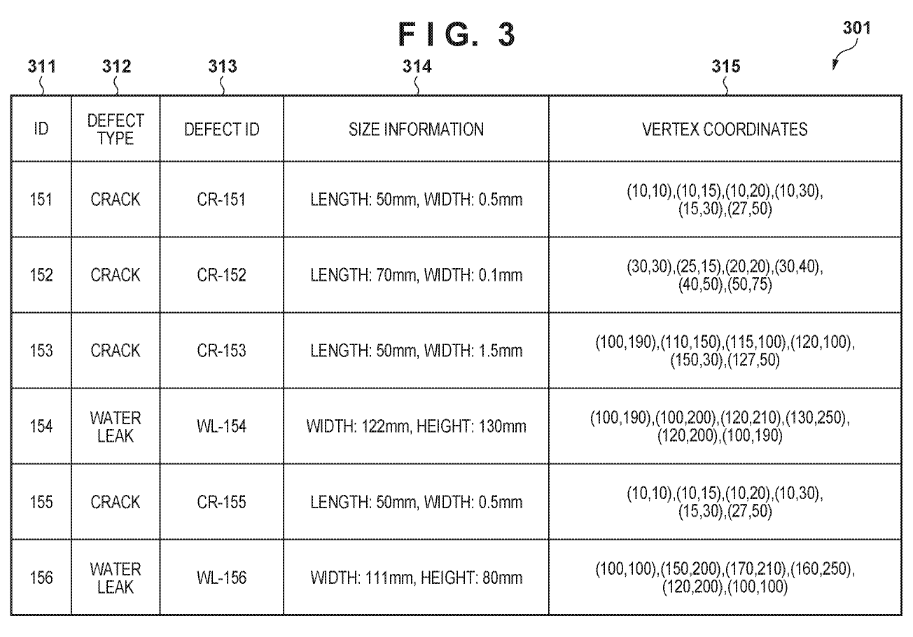

FIG. 3 is a view describing defect information stored in the image analysis result storage unit 214. A table 301 is a table that stores defect information for a plurality of defects. Each record (each defect) in the table 301 includes information of identification information (ID) 311, a defect type 312, a defect ID 313, size information 314, and vertex coordinates 315.

The ID 311 is identification information for uniquely identifying a defect. The defect type 312 stores a defect type such as a crack or water leak. The defect ID 313 is identification information in which the defect type 312 and the ID 311 are combined to improve readability. As described later, the defect ID 313 is used as a character string to be displayed on a defect label in GUI display. That is, it is identification information for facilitating determination of individual defects by the user. Here, a prefix (crack (CR), water leak (WL), and the like) indicating the defect type 312 is combined with the ID 311, but another expression may be used.

The size information 314 is information on an actual size of a defect. The defect (linear defect such as a crack) expressed by a polyline stores the length of the polyline, the width of the polyline (such as the width of a maximum opening of the crack). A defect (defect having a two-dimensional spread such as water leak) expressed by a polygon stores the maximum width in the lateral direction, the maximum height in the longitudinal direction, and the like of the polygon. The size information is not limited to this, and more detailed information or other size information may be stored. The vertex coordinates 315 are shape information of a defect, and are vertex coordinates of the polyline/polygon.

In image analysis of a captured image (inspection image), a pixel coordinate system is used in order to process the captured image in units of pixels. However, it is also possible to perform conversion to actual dimensions depending on the image resolution (mm/pixel) of the shooting target object.

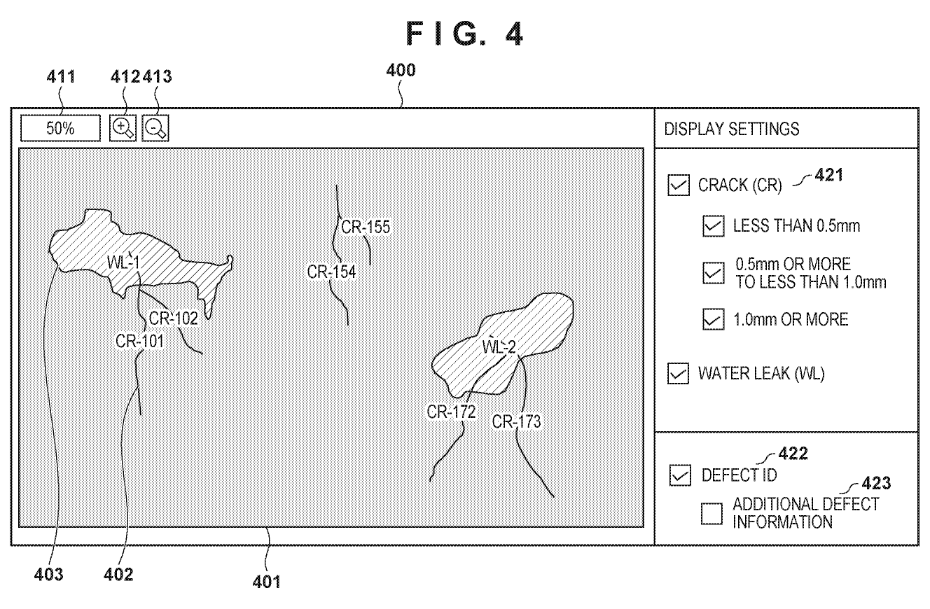

FIG. 4 is a view illustrating an example of a defect display screen (GUI) to be displayed on the display unit by the UI control unit 216. A GUI 400 is a GUI for presenting the user the inspection image and the defect detection result.

An original image 401 is (a partial region of) an inspection image obtained from the image storage unit 211. A polyline 402 is a figure in which a crack defect is drawn with a polyline. A polygon 403 is a figure in which water leak defect is drawn with a polygon. By superimposing one or more defect objects (the polyline 402 and the polygon 403) with the original image 401 as a background image, the user can visually confirm the position in the image and the size of the detected defect.

A zoom magnification display 411 is a UI component that indicates a zoom magnification of image display. Buttons 412 and 413 are UI components that control zoom-in and zoom-out. That is, by pressing (click operation or touch operation on the mouse) the buttons 412 and 413, the user can change the display magnification of the original image 401. The display in the zoom magnification display 411 is changed accordingly.

A check box 421 is a UI component that switches on/off of superimposition of the polyline 402 and the polygon 403 of the defect for each defect type. Since the defect severity of crack is roughly known by the width, a check box for switching on/off for each crack width may be provided as illustrated in FIG. 4.

A check box 422 is a UI component that switches on/off of superimposition of a defect label. As illustrated in FIG. 4, a check box 423 for switching on/off of superimposition of additional defect information may be further provided.

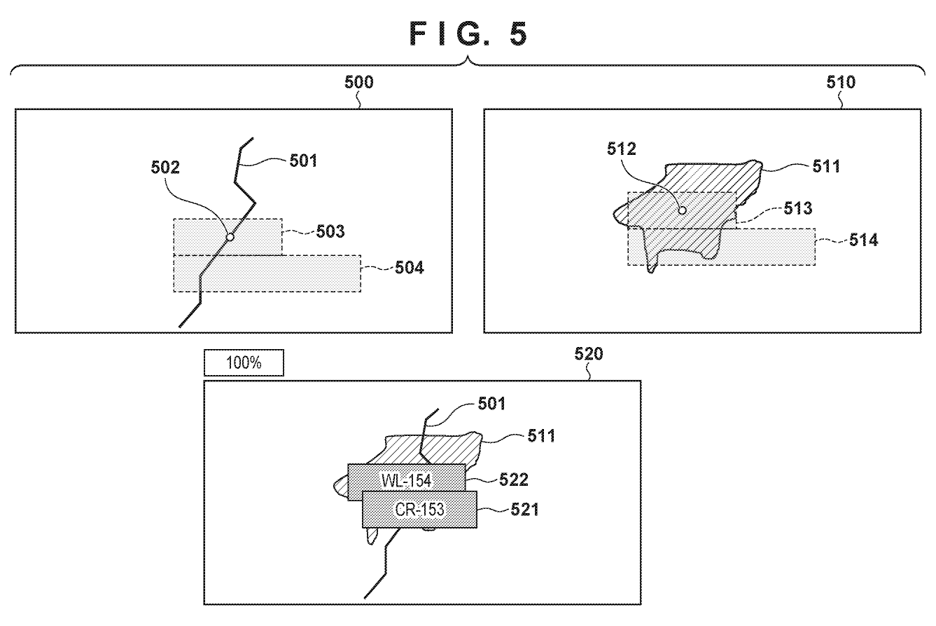

FIG. 5 is a view describing a display method for a defect ID/additional defect information. A screen 500 illustrates a determination method for a display position of an information label in a case where only a polyline exists, and the screen 510 illustrates a determination method for a display position of an information label in a case where only a polygon exists.

The screen 500 is a view illustrating an arrangement when an information label is displayed for a polyline 501 indicating a crack. A point 502 is a midpoint of the polyline 501. For example, when the polyline includes five segments (a line segment and an arc), the midpoint of the third segment at the center may be set as the midpoint of the polyline. Alternatively, the midpoint can be determined by any method, such as calculating the total length of the polyline and defining the position on the polyline of half the length as the midpoint of the polyline.

A region 503 is a label display region for the defect ID. Since the width and height of the region 503 are determined by the number of characters and the display font of the defect ID, in this example, the region 503 of the defect ID label is determined with the point 502 as the center. In this case, the region 503 is arranged such that the center in the width/height direction matches the point 502 (midpoint). The arrangement of the region 503 can be determined by any method such as arranging the left end and the upper end of the region 503 to match the point 502 (midpoint).

A region 504 is a label display region of additional defect information. Similarly to the above-described region 503, the width and height of the region 504 are determined by the number of characters and the display font of the additional defect information. The example of the screen 500 assumes that the "left end of the region 503" and the "left end of the region 504" are matched at the same position and arranged immediately below the region 503 (so as not to overlap). Note that the positions of "the center of the region 504" and "the center of the region 503" may be matched each other, or the region 504 may be arranged at the right end of the region 503. The arrangement of the regions 503 and 504 may be determined by any method.

A screen 510 is a view illustrating an arrangement in a case of superimposing an information label on a polygon 511 indicating water leak. A point 512 is the center point of the polygon 511. For example, a circumscribed rectangle of the polygon may be obtained, and the center point thereof may be set to 511. However, since there can be various shapes of the defect appearing in a structure, the center point may be determined by any method such as using the centroid of the polygon as the center point. A region 513 is a label display region of a defect ID, and a region 514 is a label display region of additional defect information. How to determine the sizes and arrangement positions of the regions 513 and 514 is similar to that of the regions 503 and 504 described above, and thus the description thereof will be omitted.

A screen 520 illustrates a display example of an information label in a case where both a polyline and a polygon overlap. A label display 521 is a label display of a defect ID for the polyline 501, and a label display 522 is a label display of a defect ID for the polygon 511. The label display 521 is displayed at a similar position to the region 503 on the screen 500, and the label display 522 is displayed at a similar position to the region 513 on the screen 510.

Since the display positions of the label display 521 and the label display 522 are close to each other, parts thereof are overlapped. Here, it is assumed that priority is designated in advance for the defect type as "crack > water leak". Therefore, the label display 521 is displayed in front of the label display 522.

Therefore, the order (from the back side) of drawing processing on the screen 520 is the original image 401, the polygon 511 (water leak), the polyline 501 (crack), the label display 522 (water leak defect ID), and the label display 522 (crack defect ID). This can perform control such that information of a defect type with a higher priority is displayed on the front.

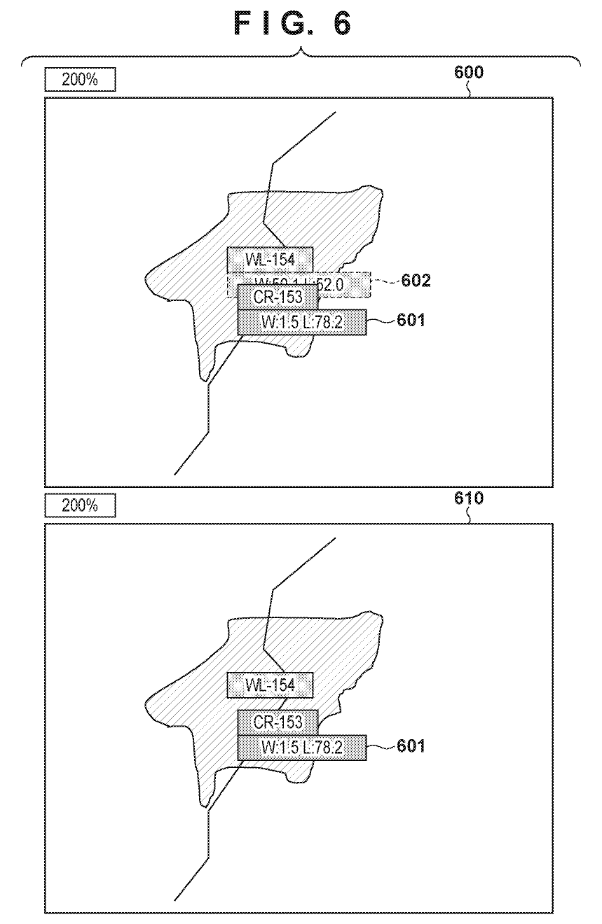

FIG. 6 is a view describing details of control in a case of displaying the defect ID and the additional defect information. A display screen 600 illustrates a display example in the GUI (FIG. 4) in a case where the zoom magnification is enlarged to 200%, for example.

A label display 601 is a label display of additional defect information for a polyline, and a label display 602 is a label display of additional defect information for a polygon. Here, the position of each label display is determined similarly to that described with reference to the screen 500 and the screen 510. An example of displaying the size information 314 as additional defect information is illustrated.

As illustrated, in the screen 600, since the label display 601 is displayed on the forefront, there is no problem occurring in readability. On the other hand, a part of the label display 602 is hidden by the "label display of the defect ID for the polyline", and a problem occurs in readability (cannot read or difficult to see characters). Displaying a large number of pieces of unnecessary information excessively to the user as in the screen 600 results in deterioration of usability. Unlike the defect ID, the additional defect information is not essential information.

Therefore, in a case where a label display overlap occurs as in the screen 600, the display is controlled as illustrated in a screen 610. Specifically, in a case where the label display 602 partially hidden by the overlap is information of low importance (additional defect information), the label display 602 is not displayed. This can provide a display screen with high readability.

### Apparatus Operation

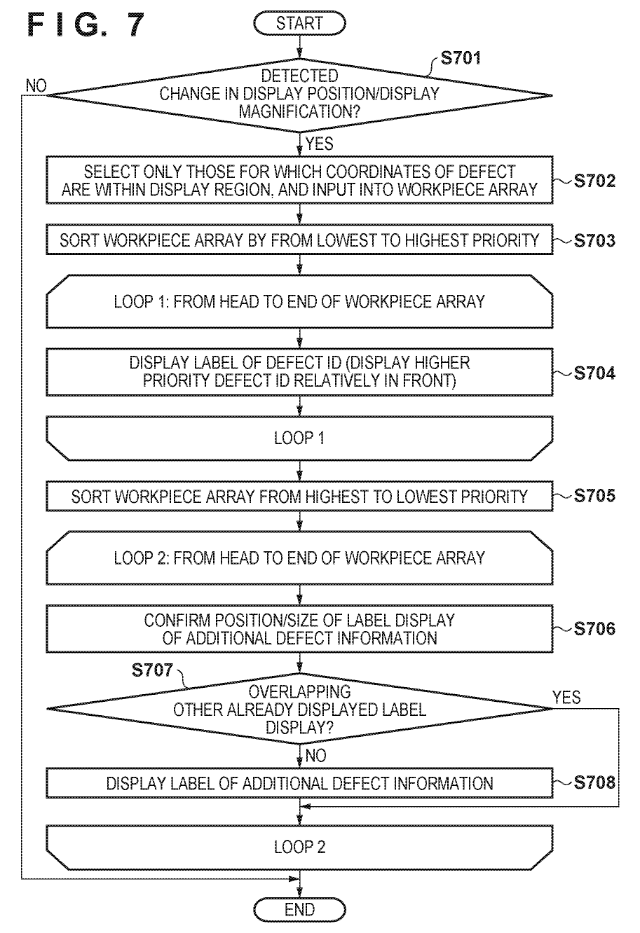

FIG. 7 is a flowchart of display control processing in the information processing apparatus. Note that the display control processing is performed by the UI control unit 216 to be implemented by the control unit 111 executing the OS or additional software installed in the OS. Note that, prior to the processing, the UI control unit 216 obtains in advance the original image and the corresponding analysis result (table 301) from the image storage unit 211 and the image analysis result storage unit 214. It is assumed that the original image is displayed on the GUI 400.

In S701, the UI control unit 216 determines whether a change in the display region (display position and/or display magnification) of the original image 401 has been detected. The change of the display region of the original image can be received by the user operating the UI component on the GUI 400 (dragging of the original image 401, pressing on the buttons 412 and 413, and the like). If Yes, the process proceeds to S702 to update the display, and if No, the process ends.

In S702, the UI control unit 216 selects and inputs, to a workpiece array, only defect information in which the coordinates of the defect are within the range of the display region from the plurality of pieces of defect information included in the table 301. In the following steps, the defect information included in the workpiece array is subjected to the processing.

In S703, the UI control unit 216 sorts the workpiece array, with the defect information in the workpiece array in ascending order of priority (lower priority toward the head of the array). Here, it is assumed that priority is assigned according to the defect type 312 as described above, but other criteria may be used for determining the priority. For example, defect information may be analyzed, and the progress degree order of defect (in descending order of crack width, in descending order of total extension of crack, in descending order of area in a case of surface shape, and the like) may be used.

In S704, loop processing is performed on from the head to the tail of the workpiece array sorted in S703 (loop 1). In S704, the UI control unit 216 displays the "defect object (polyline, polygon)" of the defect in the workpiece array, and sequentially displays the "label display of defect ID" in the order in the workpiece array (i.e., in ascending order of priority). By this, the label of the defect ID of the defect having a high priority is displayed on relatively front. Note that the "defect object (polyline, polygon)" and the "label display of defect ID" may be sequentially displayed in parallel.

In S705, the UI control unit 216 sorts the workpiece array, with the defect information in the workpiece array in descending order of priority (higher priority toward the head of the array).

In S706 to S708, loop processing is performed on from the head to the tail of the workpiece array sorted in S705 (loop 2).

In S706, the UI control unit 216 confirms the display region (position/size of the label display) of the "label display of additional defect information" in the order in the workpiece array (i.e., in descending order of priority). The additional defect information is size information in the table 301, for example, but may be other additional information. The display region (position/size of label display) of the "label display of additional defect information" is determined as in the region 504 and the region 514 described with reference to FIG. 5.

In S707, the UI control unit 216 determines whether or not the display region of the additional defect information overlaps another label display ("label display of defect ID" or "label display of additional defect information") already displayed. For example, the label display 601 in FIG. 6 is determined as "not overlapping", and the label display 602 determined after the label display 601 is determined as "overlapping". If No, the process proceeds to S708, and if Yes, S708 is skipped. In S708, the UI control unit 216 displays "label display of additional defect information".

As a result of the above-described display control, regarding the label display of the defect ID, overlapping of the label displays is permitted to perform display for all the defects in the workpiece array. However, since the label display of the defect ID of the defect having a high priority is displayed on relatively front, deterioration of the readability is less likely to occur regarding the label of the defect ID of the defect having a high priority.

Regarding the label display of the additional defect information, display is performed only for a defect having a relatively high priority among defects in which overlapping of label displays does not occur and defects in which overlapping of label displays occurs. That is, it is possible to suppress complicated display that causes deterioration in readability.

As described above, according to the first embodiment, when the label display of defect is performed, display control based on the priority of defect and the type of label display is performed. This can display defect information that can suppress deterioration in readability.

Note that, in the above-described S707, only whether or not the display region of the additional defect information overlaps another label display already displayed is determined, but the overlap degree is calculated and the presence or absence of display may be controlled based on whether the overlap degree is equal to or less than a threshold. Whether or not to permit overlapping of label displays may be switched based on designation by the user.

When the display magnification of the display screen in the GUI is enlarged beyond a predetermined magnification, the additional defect information that has not been displayed before the enlargement may be displayed at a position not overlapping with another defect ID and additional defect information. When the display magnification of the display screen in the GUI is reduced beyond a predetermined magnification, the additional defect information that has been displayed before the reduction may be not displayed.

### Modification

In the first embodiment described above, an example in which the "label display of defect ID" and the "label display of additional defect information" are a non-transmissive label display has been described. However, the display may be performed using a transmissive label display.

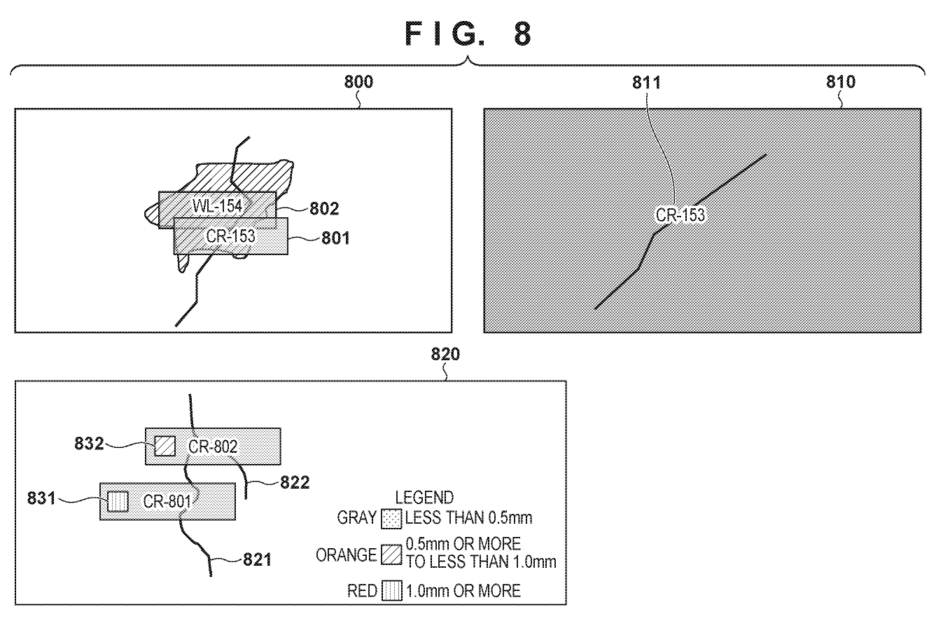

FIG. 8 is a view describing a variation of the label display.

A screen 800 illustrates an example in which the label display (rectangular region) is a transmissive image. By this, while displaying label displays 801 and 802 of the defect ID, the user can confirm the original image serving as the background and the defect object (polyline or polygon).

A screen 810 illustrates an example in which a character outline of a character string 811 of the label display is bordered and displayed in another color. Specifically, the character outline is bordered with a color different from the character color to improve the readability of the character of the label. This can improve the problem that the character string of the display label is assimilated into the background and is difficult to see when the original image serving as the background is a black object or the like.

A screen 820 illustrates an example of using not only a character string but also a graphic part such as an icon as a label display in addition to the screen 800. The defect object (polyline/polygon) is displayed in a predetermined color. For example, the color of the icon and the defect shape is set according to the width of the crack.

A solid line 821 is a polyline indicating a crack of 1.0 mm or more, and is displayed in red. A solid line 822 is a polyline indicating a crack of 0.5 mm or more and less than 1.0 mm, and is displayed in orange. An icon 831 is a red icon attached to the defect ID label corresponding to the solid line 821. An icon 832 is an orange icon attached to the defect ID label corresponding to the solid line 822. That is, the relationship between the defect object and the defect ID is displayed in an easy-to-understand manner by coloring the label display of the defect object and the defect ID according to the usage of colors indicated in the legend.

The format of the label display (defect ID/additional defect information) is not necessarily limited only to a character string, and various display styles and graphics can be used as necessary.

A character color, a background color, or a color tile of the defect label may be changeable. Furthermore, the priority may be determined according to a plurality of classifications (crack width, defect type, and the like) designated in the legend. When a mouse cursor is superimposed (hovered) on a defect label, a corresponding defect object may be highlighted.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-190897, filed October 30, 2024, which is hereby incorporated by reference herein in its entirety.

What is claimed is:

1. A display control apparatus comprising:
one or more memories storing instructions; and
one or more processors executing the instructions to:
manage defect information regarding a plurality of defects occurring in a target object; and
display information regarding one or more defects corresponding to a partial region of the target object based on the defect information, wherein
the defect information includes shape information, identification information, and additional information of each of the plurality of defects, and
the one or more processors
display one or more defect objects respectively corresponding to the one or more defects based on the shape information,
display one or more first labels indicating identification information respectively corresponding to the one or more defects, and
display a second label not overlapping the first label or the second label of another defect, and does not display at least one second label overlapping the first label or the second label of another defect, among one or more second labels indicating additional information respectively corresponding to the one or more defects.

2. The display control apparatus according to claim 1, the one or more processors further executing the instructions to:
obtain a plurality of images in which the target object is shot, wherein
display one or more images corresponding to the partial region, and superimposes the one or more defect objects, the one or more first labels, and the one or more second labels on the one or more images.

3. The display control apparatus according to claim 1 further comprising
the one or more processors further executing the instructions to receive a change of the partial region, wherein
the one or more processors update display when the one or more processors receive a change of the partial region.

4. The display control apparatus according to claim 1 further comprising
the one or more processors further executing the instructions to receive designation of priority for the plurality of defects, wherein
the one or more processors
sequentially display the first labels that correspond, in ascending order of defects, and
determine a display region of the second labels that correspond, in descending order of defects, and determines an overlap with the first label or the second label of another defect.

5. The display control apparatus according to claim 4, wherein
the priority is based on at least one of a type of defect and a progress degree of defect.

6. The display control apparatus according to claim 1, wherein
the one or more processors
determine a display region of the first label based on the shape information of a corresponding defect, and determines a display region of the second label based on the display region of the first label.

7. The display control apparatus according to claim 1, wherein
the one or more processors display the defect object and the first label corresponding to an identical defect in an identical color.

8. The display control apparatus according to claim 1, wherein
the one or more processors display the defect object and the first label in different colors depending on a progress degree of defect.

9. A display control method for displaying a defect occurring in a target object, the control method comprising:
obtaining defect information regarding a plurality of defects occurring in the target object; and
displaying, on a display, information regarding one or more defects corresponding to a partial region of the target object based on the defect information, wherein
the defect information includes shape information, identification information, and additional information of each of the plurality of defects, and
in the displaying,
one or more defect objects respectively corresponding to the one or more defects are displayed on the display based on the shape information,
one or more first labels indicating identification information respectively corresponding to the one or more defects are displayed on the display and
among one or more second labels indicating additional information respectively corresponding to the one or more defects, a second label not overlapping the first label or the second label of another defect is displayed on the display, and at least one second label overlapping the first label or the second label of another defect is not displayed on the display.

10. A non-transitory computer-readable recording medium storing a program that, when executed by a computer, causes the computer to perform a display control method for displaying a defect occurring in a target object, the control method comprising:
obtaining defect information regarding a plurality of defects occurring in the target object; and
displaying, on a display, information regarding one or more defects corresponding to a partial region of the target object based on the defect information, wherein
the defect information includes shape information, identification information, and additional information of each of the plurality of defects, and
in the displaying,
one or more defect objects respectively corresponding to the one or more defects are displayed on the display based on the shape information,
one or more first labels indicating identification information respectively corresponding to the one or more defects are displayed on the display and
among one or more second labels indicating additional information respectively corresponding to the one or more defects, a second label not overlapping the first label or the second label of another defect is displayed on the display, and at least one second label overlapping the first label or the second label of another defect is not displayed on the display.
